(19) United States
(12) Patent Application Publication
(10) Pub. No.: US 2011/0180456 A1
(43) Pub. Date: Jul. 28, 2011

(54) Integrated Process and System for Steam Cracking and Catalytic Hydrovisbreaking with Catalyst Recycle

(76) Inventors: Stephen Mark Davis, Humble, TX (US); Paul F. Keusenkothen, Houston, TX (US); Jonathan Martin Mcconnachie, Annandale, NJ (US); Larry L. Iaccino, Seabrook, TX (US); Richard C. Stell, Houston, TX (US)

(21) Appl. No.: 12/692,222

(22) Filed: Jan. 22, 2010

(51) Int. Cl. C10G 65/10; B01J 8/00

(52) U.S. Cl. 208/61; 208/68; 422/609; 422/620

(57) ABSTRACT

This invention relates to a process for cracking hydrocarbon feedstock containing resid comprising:
(a) heating a hydrocarbon feedstock containing resid;
(b) adding molecular hydrogen to said heated feedstock to form a mixture stream;
(c) adding a catalyst containing metal-sulfide particles to said heated feedstock and/or said mixture stream;
(d) reacting said mixture in a catalytic hydrovisbreaking reactor under conditions of temperature, pressure and residence time sufficient to catalytically hydrovisbreak at least a portion of said resid into hydrovisbroken hydrocarbon components;
(e) passing said reacted mixture stream into a high pressure separator and separating hydrogen from said reacted mixture;
(f) passing said reacted mixture through a knockout drum to remove catalyst and unreacted or uncracked resid as a bottoms stream; and
(g) passing said catalytically hydrovisbroken hydrocarbon components into a steam cracking furnace and thermally cracking said hydrocarbon components to form light olefins, alternately the knockout drum of step (f) is integrated into the steam cracking furnace of step (g).

### FIELD OF THE INVENTION

The invention relates to a method of making olefins from a crude or resid-containing crude fraction.

### BACKGROUND OF THE INVENTION

Thermal cracking of hydrocarbons is a petrochemical process that is widely used to produce olefins such as ethylene, propylene, butylenes, butadiene; aromatics such as benzene, toluene, and xylenes; and hydrogen. Each of these is a valuable commercial product in its own right. For instance, the olefins may be oligomerized (e.g., to form lubricant basestocks), polymerized (e.g., to form polyethylene, polypropylene, and other plastics), and/or functionalized (e.g., to form acids, alcohols, aldehydes and the like), all of which have well-known intermediate and/or end uses. One thermal cracking process is steam cracking, which involves cracking hydrocarbons in the presence of steam or steam-containing gases.

Typically in steam cracking, a hydrocarbon feedstock for steam cracking, such as naphtha, gas oil, or other non-resid containing fractions of whole crude oil, which may be obtained, for instance, by distilling or otherwise fractionating whole crude oil, is usually preheated, then mixed with steam and introduced to a steam cracker. Conventional steam cracking utilizes a pyrolysis furnace that generally has two main sections: a convection section and a radiant section. In the conventional pyrolysis furnace, the hydrocarbon feedstock enters the less severe convection section of the furnace as a liquid (except for light feedstocks which enter as a vapor) wherein it is heated and vaporized by indirect contact with hot flue gas from the radiant section. Steam may be added to the pyrolysis furnace. The vaporized feedstock and steam mixture (if present) is then introduced through crossover piping into the radiant section where it is quickly heated, at pressures typically ranging from about 10 to about 50 psig (69-345 kPa-gauge), to a severe hydrocarbon cracking temperature, such as in the range of from about 1450° F. (788° C.) to about 1650° F. (900° C.), to provide thorough thermal cracking of the feedstream. The resulting products, comprising olefins, leave the pyrolysis furnace for further downstream separation and processing.

After cracking, the effluent from the pyrolysis furnace contains gaseous hydrocarbons of great variety, e.g., saturated, monounsaturated, and polyunsaturated, and can be aliphatic and/or aromatic, as well as significant amounts of molecular hydrogen. The cracked product is then further processed such as in the olefin production plant to produce, as products of the plant, the various separate individual streams of high purity, i.e., hydrogen, the light olefins ethylene, propylene, butylenes, and aromatic compounds, as well as other products such as pyrolysis gasoline.

As worldwide demand for light olefins increases and the availability of favorable crude sources is depleted, it becomes necessary to utilize heavier crudes (i.e., those having higher proportions of resid), which requires increased capital investments to process and handle the refining byproducts. It is highly desirable to have processes that can take lower cost, heavier crudes, and produce a more favorable product mix of light olefins, more efficiently. However, conventional steam cracking processes are known to be prone to severe fouling by feedstocks containing even small concentrations of resid, which is commonly present in low quality, heavy feeds. Thus, most steam cracking furnaces are limited to processing of higher quality feedstocks which have had the resid fraction removed in other refinery processes. Such additional processes increase the cost of the overall process. Likewise, removal of the resid fraction lowers the overall conversion efficiency of the refinery process, since most of the resid fraction is mixed with low value fuel oils, rather than being converted to higher-value materials.

Cracking of hydrocarbon feeds by hydrogenation or visbreaking reactions has been described. For example, U.S. Pat. No. 3,898,299, incorporated herein by reference, discloses normally gaseous olefins produced from an atmospheric petroleum residue feedstock by: (a) contacting the feedstock in a hydrogenation zone with a hydrogenation catalyst, (b) separating from the hydrogenated feedstock a gaseous phase containing hydrogen and a liquid phase containing hydrocarbons, (c) recycling at least a portion of said gaseous phase containing hydrogen to said hydrogenation zone, (d) separating the liquid phase from (c) into a distillate fraction having a boiling range below 650° F. (345° C.) and a residue fraction having a higher boiling range, advantageously by vacuum distillation, (e) subjecting the distillate fraction from (d) to thermal cracking in the presence of steam thereby converting at least a portion of the liquid phase to normally gaseous hydrocarbons, and (f) recovering the normally gaseous olefins from the pyrolysis zone effluent.

U.S. Pat. No. 5,024,751, incorporated herein by reference, discloses a process of catalytic hydrovisbreaking of a hydrocarbon charge comprising mixing the charge with a hydrogen-containing gas, introducing into the mixed charge between 10 to 2000 ppm, based on the weight of the charge, a catalytic composition comprising a metal and an organic polysulfide, and subjecting the so-formed mixture to hydrovisbreaking conditions for a time sufficient for carrying out the hydrovisbreaking of the charge.

U.S. Pat. No. 5,413,702, incorporated herein by reference, discloses a process of visbreaking a residual oil to produce fuel oil or distillate by visbreaking at a high severity in a liquid phase in a fluidized bed reactor and a hydrogen quench in the settling zone. The visbreaker effluent and hydrogen are then hydrotreated to stabilize the product by saturating unstable species such as olefins.

U.S. Pat. No. 6,210,561, incorporated herein by reference, discloses an integrated process for converting a hydrocarbon feedstock having components boiling above 100° C. into steam cracked products by passing the feedstock to a hydrotreating zone to effect substantially complete decomposition of organic sulfur and/or nitrogen compounds. The product from the hydrotreating zone is passed to a steam cracking zone to produce C1 to C₄ hydrocarbons, steam cracked naphtha, steam cracked gas oils and steam cracked tar.

U.S. Pat. No. 7,220,887, incorporated herein by reference, discloses a process for cracking hydrocarbon feedstock containing resid comprising: heating the feedstock, mixing the heated feedstock with a fluid and/or a primary dilution steam stream to form a mixture, flashing the mixture to form a vapor phase and a liquid phase which collect as bottoms and removing the liquid phase, separating and cracking the vapor phase, and cooling the product effluent, wherein the bottoms are maintained under conditions to effect at least partial visbreaking. The visbroken bottoms may be steam stripped to recover the visbroken molecules while avoiding entrainment of the bottoms liquid. An apparatus for carrying out the process is also provided.

U.S. Patent Application Publication No. 2007/0090018, incorporated herein by reference, discloses integration of hydroprocessing and steam cracking A feed comprising crude or resid-containing fraction thereof is severely hydrotreated and passed to a steam cracker to obtain an olefins product.

Other patents of interest related to cracking heavy feeds include U.S. Pat. No. 4,257,871, to Wernicke; U.S. Pat. No. 4,065,379, to Soonawala; U.S. Pat. No. 4,180,453, to Franck; and U.S. Pat. No. 4,210,520, to Wernicke.

There remains in the art a need for new means and improved processes for economical processing of heavy, resid-containing feeds for the production of olefins, aromatics, and other valuable petrochemical products. All known art previous to this invention, has deficiencies, shortcomings, or undesirable aspects.

### SUMMARY OF THE INVENTION

A steam cracking furnace (also referred to as a “steam cracker”) is a pyrolysis furnace that has two main sections: a convection section and a radiant section, where hydrocarbon feedstock enters the less severe convection section of the furnace as a liquid (except for light feedstocks which enter as a vapor) and where the feedstock is heated and vaporized by indirect contact with hot flue gas from the radiant section and is optionally contacted with steam. The vaporized feedstock and steam mixture (if present) is then introduced through crossover piping into the radiant section where it is quickly heated, at pressures typically ranging from about 10 to about 50 psig (69 to 345 kPa), to a severe hydrocarbon cracking temperature, such as in the range of from about 1450° F. (788° C.) to about 1650° F. (900° C.), to provide thorough thermal cracking of the feedstream. The resulting products typically comprise olefins.

In a first embodiment, the invention is directed to a process for cracking hydrocarbon feedstock containing resid comprising: (a) heating a hydrocarbon feedstock containing resid; (b) adding a molecular hydrogen (typically a molecular hydrogen containing gas) to said heated feedstock to form a mixture stream; (c) adding a catalyst containing metal-sulfide particles to said heated feedstock and/or to said mixture stream; (d) reacting said mixture in a catalytic hydrovisbreaking reactor under conditions of temperature, pressure and residence time sufficient to catalytically hydrovisbreak at least a portion of said resid into hydrovisbroken hydrocarbon components (preferably said hydrovisbroken hydrocarbon components are suitable for steam cracking (i.e., the feedstock can be cracked into hydrocarbons having a lower carbon number than the unvisbroken feed)); (e) passing said reacted mixture stream into a high pressure separator and separating hydrogen from said reacted mixture; (f) passing said reacted mixture through a low pressure separator (also referred to as a knockout drum) to remove catalyst and unreacted and uncracked resid as a bottoms stream; and (g) passing said catalytically hydrovisbroken hydrocarbon components into a steam cracking furnace and thermally cracking said hydrocarbon components to form light olefins. In an alternate embodiment the knockout drum of step (f) is integrated into the steam cracking furnace of step (g).

The process can further be conducted wherein said hydrocarbon feedstock is heated in a convection section of a first steam cracking furnace, and further comprising separating (such as by flashing) said heated hydrocarbon feedstock to form an overhead vapor phase and a liquid bottoms phase containing said resid in a first knockout drum integrated with said convection section of said first steam cracking furnace.

In another embodiment, the steam cracking furnace of step (g) is a second steam cracking furnace comprising a second integrated knockout drum, wherein said catalytically hydrovisbroken hydrocarbon components are flashed to form an overhead vapor phase and an unconverted liquid bottoms phase.

In a particularly preferred embodiment, this invention relates to:

A process for cracking hydrocarbon feedstock containing resid comprising:

(1) heating a hydrocarbon feedstock containing resid in a convection section of a first steam cracking furnace;

(2) passing said heated hydrocarbon feedstock containing resid to a first knockout drum integrated with said convection section of said first steam cracking furnace and separating (such as by flashing) said heated hydrocarbon feedstock to form an overhead vapor phase and a liquid bottoms phase containing said resid;

(3) adding molecular hydrogen to said liquid bottoms phase to form a mixture stream;

(4) adding a catalyst containing metal-sulfide particles to said liquid bottoms phase and/or said mixture stream;

(5) reacting said mixture in a catalytic hydrovisbreaking reactor under conditions of temperature, pressure and residence time sufficient to catalytically hydrovisbreak at least a portion of said resid into hydrovisbroken hydrocarbon components;

(6) passing said reacted mixture stream into a high pressure separator and separating hydrogen from said reacted mixture;

(7) optionally passing said reacted mixture to a convection section of a second steam cracking furnace;

(8) passing said reacted mixture exiting the high pressure separator and or the convection section of the second steam cracking furnace through knockout drum integrated into the second steam cracking furnace to form a vapor phase containing catalytically hydrovisbroken hydrocarbon components and to remove catalyst and unreacted or uncracked resid as a bottoms stream; and

(9) passing the vapor phase containing catalytically hydrovisbroken hydrocarbon components into the radiant section of the second steam cracking furnace and thermally cracking said hydrocarbon components to form light olefins. In a preferred embodiment, the hydrocarbon feedstock is not cooled when passing from the convection section of the first steam cracking furnace to the integrated first knockout drum. By not cooled is meant that the feedstock does condense into a liquid and preferably does not drop in temperature by more than 30° C. (alternately by not more than 50° C., alternately by not more than 100° C.). In another preferred embodiment, the pressure of the liquid bottoms phase containing said resid produced in step (2) is increased prior to adding hydrogen and/or entering the catalytic hydrovisbreaking reactor. By increased is meant that the pressure is raised to meet or exceed the pressure of the catalytic hydrovisbreaking reactor, preferably the pressure is raised by 10 psi (69 kPa) or more, alternately by 50 psi (345 kPa) or more, alternately by 100 psi (690 kPa) or more.

Conveniently, the process can further comprise recovering said catalyst by filtering at least a portion of unconverted liquid bottoms from said second integrated knockout drum to form a retentate containing catalyst (preferably rich in catalyst) and a filtrate of unconverted liquid bottoms, and recycling said retentate containing catalyst into said catalytic hydrovisbreaking reactor.

Advantageously, the process can further comprise blending said filtrate with other refining process streams to produce fuel oil products.

Preferably, the catalytic hydrovisbreaker is charged with a catalyst load of between 0.1 wt % and 10 wt %, or between 0.5 wt % and 7.5 wt %, or even between 0.5 wt % and 5 wt %, based on the weight of the hydrocarbon feedstock containing resid introduced into said hydrovisbreaker.

Advantageously, the process can further comprise conducting said catalytic hydrovisbreaking under conditions sufficient to convert at least 60 wt % of said resid, preferably between 60 wt % and 80 wt % of said resid. Advantageously, the process can catalytically hydrovisbreak at least a portion of said resid into hydrovisbroken hydrocarbon components, preferably at least 10 wt % of said resid are visbroken into hydrovisbroken hydrocarbon components, preferably at least 20 wt %, preferably at least 30 wt %, preferably at least 40 wt %, preferably at least 50 wt %, preferably at least 60 wt %, preferably from 60 wt % to 80 wt % of said resid are visbroken into hydrovisbroken hydrocarbon components.

Advantageously, the process can be conducted such that said hydrocarbon feedstock contains between 10 wt % and 50 wt % of resid boiling at 566° C.+.

In another embodiment, the invention is directed to a system for cracking hydrocarbon feedstock containing resid comprising: (a) a first steam cracking furnace having a first knockout drum integrated with a convection section of said first furnace; (b) a catalytic hydrovisbreaking reactor downstream of and in fluid communication with a liquid bottoms extraction portion of said first knockout drum; and (c) a second steam cracking furnace having a second knockout drum integrated with a convection section of said second furnace, and a radiant cracking section; wherein an inlet of said second steam cracking furnace is downstream of and in fluid communication with said catalytic hydrovisbreaking reactor, and a liquid bottoms extraction portion of said second knockout drum is in fluid communication with said catalytic hydrovisbreaking reactor.

The system may also further comprise a stripping gas line connected to said second knockout drum.

Additionally, the system can further comprise a filtration unit disposed between the liquid bottoms extraction portion of said second knockout drum and said catalytic hydrovisbreaker reactor.

In another embodiment, any process described here is a continuous process. By continuous is meant that the process operates without cessation or interruption. For example a continuous process to produce olefins would be one where the reactants are continually introduced into one or more reactors and olefin product is continually withdrawn.

These and other objects, features, and advantages will become apparent as reference is made to the following detailed description, preferred embodiments, examples, and appended claims.

### BRIEF DESCRIPTION OF THE DRAWINGS

In the Figures below, similar apparatuses and/or process steps are identified with like numbers.

FIG. 1 is a flow diagram of an embodiment of the present invention process.

FIG. 2 is a diagram of a catalytic hydrovisbreaking reactor useful in the present process.

### DETAILED DESCRIPTION OF THE INVENTION

This invention involves integration of a heavy feed steam cracker including an integrated vacuum resid knockout drum with a catalytic hydrovisbreaking (CHVB) reactor where vacuum resid is converted to lighter components that are suitable for steam cracking “Suitable for steam cracking” means that the materials can be cracked in a steam cracker. The reactor is operated with a higher catalyst loading than is normally utilized in once through operations (e.g., about 0.1 wt % to 10 wt %, even between about 0.5 wt % to 5 wt %, based on the weight of the hydrocarbon feedstock containing resid entering the CHVB reactor). In this manner, the catalytic hydrovisbreaking process is able to combine hydrogen addition, with Conradson Carbon (CCR) conversion, boiling range conversion, demetallization, and higher levels of desulfurization.

Catalyst is efficiently recovered and recycled within the process by operating the resid conversion process at 60 wt % to 80 wt % 1050° F.+ (566° C.+) resid conversion and partially filtering the unconverted bottoms from the integrated knockout drum using sintered metal filter elements, screens, or other filters suitable for hot process streams. Metals-free filtrate from filtration is used in fuel oil or refinery processing, whereas the catalyst-rich retentate is mixed with fresh feed and recycled to the hydrovisbreaking process.

Lighter liquids and gases produced in the catalytic hydrovisbreaking process are preheated in the convection section of a steam cracking furnace, mixed with steam, further preheated, then conveyed to the radiant section of the steam cracker without condensation. By closely integrating the two conversion processes, the overall process is able to efficiently convert a much wider range of heavy feeds to high value chemicals while minimizing fouling.

According to the invention a crude oil or fraction thereof containing resid is utilized as a feedstock for a steam cracking furnace. Suitable lower value feeds may typically include heavier crudes, those hydrocarbon feedstocks that have high concentrations of resid (especially vacuum resid), high sulfur, high Total Acid Number (TAN), high aromatics, and/or low hydrogen content.

Crude, as used herein, means whole crude oil as it issues from a wellhead, production field facility, transportation facility, or other initial field processing facility, optionally including crude that has been processed by a step of desalting, treating, and/or other steps as may be necessary to render it acceptable for conventional distillation in a refinery. Crude as used herein is presumed to contain resid.

Crude fractions are typically obtained from the refinery pipestill. Although any crude fraction obtained from the refinery pipestill may be useful in the present invention, a significant advantage offered by the present invention is that crude or crude fractions still containing all or a portion of the original resid present in the whole crude obtained from the wellhead may be used as feed for a steam cracker. In one embodiment, the crude or other feedstock to the present system may comprise at least about 1 wt % resid, preferably at least about 5 wt % resid, preferably at least about 10 wt % resid, preferably at least about 20 wt % resid up to about 50 wt % resid.

Resid as used herein refers to the complex mixture of heavy petroleum compounds otherwise known in the art as residuum or residual. Atmospheric resid is the bottoms product produced in atmospheric distillation when the endpoint of the heaviest distilled product is nominally 650° F. (343° C.), and is referred to as 650° F.+ (343° C.+) resid. Vacuum resid is the bottoms product from a column under vacuum when the heaviest distilled product is nominally 1050° F. (566° C.), and is referred to as 1050° F.+ (566° C.+) resid. (The term “nominally” means here that reasonable experts may disagree on the exact cut point for these terms, but probably by no more than +/−50° F. or at most +/−100° F.) This 1050° F.+ (566° C.+) portion contains asphaltenes, which traditionally are considered to be a problem for the steam cracker, resulting in severe fouling and potentially corrosion or erosion of the apparatus. The term “resid” as used herein means both the 650° F.+ (343° C.±) resid and the 1050° F.+ (566° C.+) resid unless otherwise specified (note that 650° F.+ resid comprises 1050° F.+ resid). According to this invention, at least a portion of the 650° F.+ resid, up to at least the 1050° F.+ boiling point fraction, is vaporized, such as when combined with steam, and/or when the pressure is reduced or flashed in the knockout drum of the steam cracker.

Resid typically contains a high proportion of undesirable impurities such as metals, sulfur and nitrogen, as well as high molecular weight naphthenic acids (measured in terms of TAN according to ASTM D-664). Yet another advantage of the present invention is that feeds high in one or more of these impurities may be readily processed.

In a preferred embodiment, wherein the feed comprises crude or atmospheric resid that contain appreciable amounts of 1050° F.+ (566° C.+) resids, e.g., 10 wt % or more of resid, or 20 wt % or more of resid, or even up to 50 wt % of resid, the resid-containing feed may be passed into the convection section of a pyrolysis unit, where it is heated and mixed with superheated steam. Then the heated mixture may be passed to a knockout drum (or pressure reduction device), which is integrated with the pyrolysis unit, to drop out the heaviest fraction (e.g., substantially all of the asphaltenes). The terms “knockout drum” and knockout pot” are used interchangeably herein; they are known in the art, meaning generally, a vessel or system to separate a liquid phase from a vapor phase. The term “flash” means generally to effect a phase change for at least a portion of the material in the vessel from liquid to vapor, via a reduction in pressure and/or an increase in temperature. Thus the terms “flash drum” and “flash pot” indicate a vessel where phase change for at least a portion of the material in the vessel from liquid to vapor occurs. The addition of steam well upstream of the knockout drum, required for steam cracking, will reduce the hydrocarbon partial pressure, which effects vaporization of the 750° F.+ (399° C.) to 1050° F.+ (566° C.+) (preferably even a substantial portion of the 1100° F.+ (593° C.+)) resid fractions, and prevent fouling.

Preferred knockout drums or vapor liquid separation devices, and their integration with pyrolysis units have previously been described in U.S. Patent Application Publication Nos. 2004/0004022, 2004/0004027, and 2004/0004028, which are incorporated herein by reference. Another apparatus effective as a flash pot for purposes of the present invention is described in U.S. Pat. No. 6,632,351 as a “vapor/liquid separator”.

The knockout drum preferably operates at a temperature of between about 800° F. (about 425° C.) and about 870° F. (about 465° C.), but also typically not over about 900° F. (about 482° C.). Separating material through the knockout drum to obtain an overhead vapor and liquid bottoms further facilitates vaporization of the 650° F.+ (343° C.+) resids.

Steam cracking alone provides for a product comprising significant yields of fuel oil, tar, and non-aromatic SCN (steam cracked naphtha) in addition to the desired ethylene, propylene, butylenes, C₅ olefins and dienes, cyclic dienes (the primary C₅ from steam cracking is typically cyclopentadiene], and single-ring aromatic products. The catalytic hydrovisbreaking process is particularly effective and advantageous for steam cracker integrations for several reasons: the process achieves higher resid conversion without fouling as compared to conventional visbreaking or hydrovisbreaking with lower catalyst loadings; the process achieves higher resid conversion versus conventional resid hydroprocessing without experiencing product compatibility (hot filtration sediment) limitations; the process can achieve similar light liquid yields as compared to more complex coking processes; and because catalytic hydrovisbreaking adds hydrogen, product quality is improved versus coking or visbreaking

Liquid products from this process produce higher yields of chemicals in the steam cracker and show reduced tendency for fouling the steam cracking furnace. Catalytic hydrovisbreaking also provides a higher level of resid desulfurization which simplifies use of steam cracker liquid byproducts and/or residual oils for producing fuels.

The catalytic hydrovisbreaking process is preferably operated in the range of 10 wt % or more 1050° F.+ (566° C.+) conversion, preferably 20 wt % or more, preferably 30 wt % or more, preferably 40 wt % or more, preferably 50 wt % or more, preferably 60 wt % or more. In a particularly preferred embodiment, the catalytic hydrovisbreaking process is operated in the range of 60 wt % or more 1050° F.+ (566° C.+) conversion, preferably 60 wt % to 80 wt % 1050° F.+ (566° C.+) conversion, e.g., 60 wt % or more of the 1050° F.+ (566° C.+) resid is converted to hydrocarbon components suitable for steam cracking, preferably 60 wt % to 80 wt % of the 1050° F.+ (566° C.+) resid is converted to hydrocarbon components suitable for steam cracking, alternately up to 95 wt % of the 1050° F.+ (566° C.+) resid is converted to hydrocarbon components suitable for steam cracking. In this window, hydrogen consumption will typically vary in the range of 400-1000 standard cubic feet per barrel (71-178 m³H₂/m³crude) and feed desulfurization (based on liquid products) will typically be greater than 40%, preferably greater than 50%, preferably greater than 50%, alternately in the range of 40-90%. Higher levels of hydrogen addition and desulfurization can be achieved with longer reaction times, more active catalyst formulations, and higher catalyst concentrations.

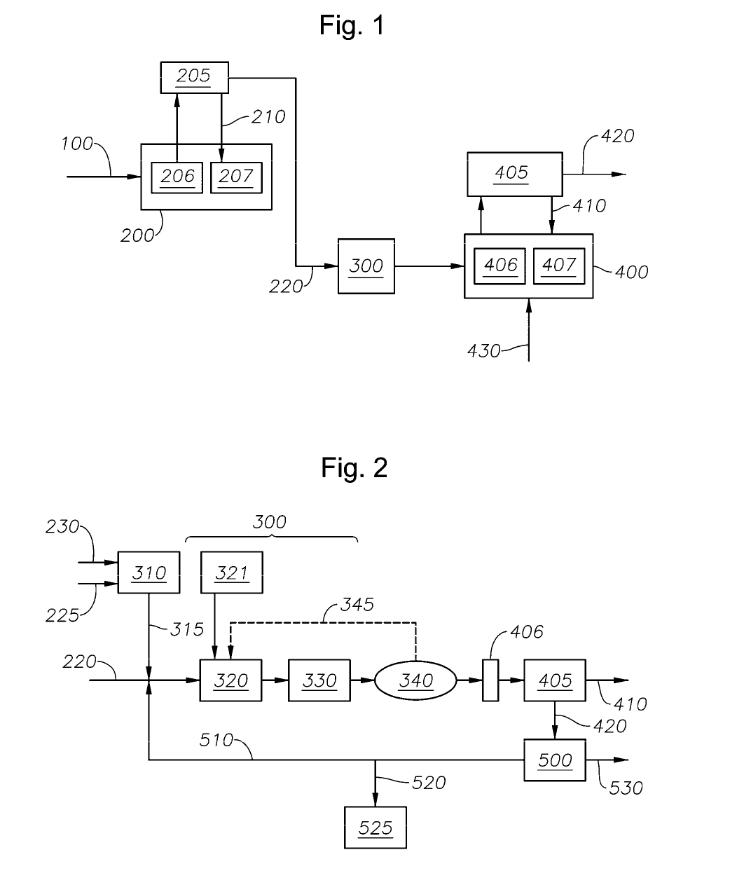

The basic flow scheme of the process is shown in FIG. 1. A heavy feedstock 100 containing about 10 wt % to 50 wt % molecules boiling in the vacuum resid range (566° C.+) is heated, such as by feeding it to a first steam cracking furnace 200 having a convection section 206, a radiant section 207 and an integrated knockout drum 205. Typically the whole feed is heated in the convection section of the furnace 206 and then passes into the knockout drum separation device 205 where molecules boiling below about 1000-1100° F. (538-593° C.) are vaporized (or remain vaporized) and are separated from heavier compounds which remain in the liquid phase. Material typically enters the knockout drum at a temperature of about 800-870° F. (427-465° C.) and vaporization (flashing) can be facilitated by the use of steam stripping or stripping with light hydrocarbons. The vapors pass overhead via line 210 into the radiant section 207 of the first steam cracking furnace, whereas the heavy liquids are withdrawn from the bottom of the knockout drum through line 220. The heavy liquid molecules including resid are then directed to the catalytic hydrovisbreaking reactor 300. Heavy liquids from several knockout drum equipped furnaces are preferably combined to achieve better economy of scale. In the catalytic hydrovisbreaking reactor 300, the heavy oil is mixed with catalyst and a molecular hydrogen-containing gas (e.g., H₂, fuel gas (preferably H₂ rich fuel gas), syngas (preferably syngas where all the CO has been removed)) and a high fraction of the vacuum resid molecules, such as at least about 60 wt %, even between about 60 wt % to 80 wt %, or even up to 95 wt %, are converted into lighter molecules which boil below 1050° F. (566° C.). Typical operating conditions include temperatures of 800-900° F. (427-482° C.), residence times of 2-100 minutes, hydrogen treat rates of 500-5000 SCF/B (89-891 m³H₂/m³crude), and operating pressures of 100-3000 psig (0.7-21 MPa-gauge). Preferred conditions are about 820-860° F. (438-460° C.), 10-40 min, 1000-2500 SCF/B (178-445 m³H₂/m³crude), and 500-1200 psig (3.5-17 MPa-gauge). Synthesis gas (“syngas”), is a gas comprising CO and H₂ typically derived from natural gas, algae and/or coal. Syngas may also contain CO₂, H₂O and N₂.

Typical reactor designs include a coil reactor, a coil reactor combined with a pumparound soaker, or a slurry bubble column with liquids recirculation, although other designs are possible. In general, the reaction conditions are optimized to match feed quality, e.g., lower quality feeds may require more severe conditions to achieve high conversions in the range of 50 wt % to 95 wt %, preferably about 60 wt % to 80 wt %. Conventional facilities (high and low pressure separators) are used to remove vapor and liquid products after the reactor and to recycle unused hydrogen to the process.

In a preferred embodiment, vapor and liquid products from the catalytic hydrovisbreaking process are fed to a second steam cracking furnace 400 having a convection section 406, a radiant section 407 and incorporating an integrated knockout drum 405. This furnace may be operated with a slightly lower knockout drum temperature or cut point as compared to the first furnace (or group of furnaces used to supply the feed). Lighter molecules generated in the hydrovisbreaking are (or remain) vaporized, optionally with the aid of steam stripping, which steam can be introduced through line 430. The lighter molecules pass from the second knockout drum 405 via line 410 into the radiant section of the steam cracker, whereas heavy VGO molecules, catalyst, and resid that were not converted in the hydrovisbreaker are withdrawn from the bottom of the second knockout drum through line 420.

FIG. 2 illustrates a preferred embodiment of the invention, with details of a suitable catalytic hydrovisbreaking reactor 300 system. The heavy liquids are withdrawn from the bottom of the knockout drum through line 220, are mixed with fresh visbreaking catalyst 315, which is prepared in catalyst pre-former 310, which itself is fed with a portion of the resid-containing feed 225 and a catalyst precursor 230, as well as with recycled catalyst from catalyst recycle line 510. The heavy liquid/catalyst mixture is fed to a heater 320 and mixed with hydrogen from hydrogen recycle line 345 as well as fresh hydrogen 321. The mixture is then conveyed to a pumparound soaker 330 for catalytic hydrovisbreaking of the heavy liquid/resid mixture. The reaction products are passed through a high pressure separator 340, wherein unreacted hydrogen is separated from the liquefied hydrocarbons/catalyst mixture. The separated hydrogen is recycled to heater 320 through line 345 or purged, while the heavy liquid/catalyst mixture is conveyed to the convection section 406 of the second steam cracking furnace 400 (FIG. 1) for heating, mixing with steam and vaporization of the heavy liquid. The heated mixture is then conveyed into the integrated knockout drum 405, where vaporized hydrocarbons 410 are separated from any remaining heavy liquids and catalyst, which are withdrawn from the knockout drum as a bottoms stream 420. In a preferred embodiment the hydrovisbroken components exiting the hydrovisbreaker 330 are reduced in temperature prior to introduction into the high pressure separator 340, typically by using a heat exchanger (not shown). By reduced in temperature is meant the temperature is reduced by at least 10° C., preferably be at least 50° C., preferably by at least 100° C.

Catalyst is then filtered from the heavy oil slurry and recycled back to the hydrovisbreaking process through line 510. This is preferably accomplished by cooling the heavy slurry to about 200-500° F. (93-260° C.) and passing the slurry into a crossflow filtration process 500 using sintered metal candle filters with a pore opening size of about 0.01 to 10 micrometers, preferably about 0.1 to 1 micrometers. Heavy oil permeates through the pores, whereas about 99% or more of the catalyst is retained in the retentate. The filtration is carried out to a level where about 40-80% of filtration feed material is recovered as filtrate 530. The filtrate is preferably utilized into refinery processing or fuel oil blending, or optionally all or part can be recycled to the beginning of the CHVB process and mixed with incoming feed 220. Retentate 510 containing a high catalyst concentration can be recycled to the hydrovisbreaking process where it is mixed with fresh feed 220 and reused.

While the filtration process is operated semi-continuously, over time the pores may become blocked or blinded by catalyst and carbonaceous particles. Good filtration performance can be recovered by backwashing the filter with clean heavy oil or other methods familiar to those skilled in the art of filtration. In a preferred embodiment, filtrate molecules are disposed by other means, for example, blending into fuel oil, and are not recycled back to the hydrovisbreaker as normally practiced in fuels processes.

Catalysts used in the catalytic hydrovisbreaking process are normally based on micrometer or sub-micrometer-sized metal sulfide particles dispersed in a carbonaceous matrix (a.k.a. Microcat®). The Microcat® can be based on molybdenum sulfide; other transition metal sulfides such as those produced from tungsten, vanadium, iron, nickel, and cobalt; or molybdenum sulfide in combination with one or more of these alternative transition metal sulfides, or combinations of the alternative transition metal sulfides. While molybdenum alone provides satisfactory operations for many feeds, use of other metals or multimetallic catalyst systems can provide improved performance for resid conversion, hydrogen addition, and desulfurization, e.g., higher catalytic activity.

Fresh catalyst is typically formed by mixing a heavy VGO cut with a low cost catalyst precursor such as ammonium heptamolybdate or phosphomolybdic acid and heating to 600-800° F. (316-427° C.) for 10-60 minutes. Catalyst pre-forming is preferably carried out in the presence of hydrogen and H₂S or elemental sulfur. The Microcat® produced in this manner is stable over many cycles of conversion, filtration, and reuse. However, the catalyst can deactivate over long times. For this reason, it may be advantageous to remove a small purge stream 520 from the concentrated retentate stream 510. This “spent” catalyst can be regenerated in separate facilities 525 or reformulated into fresh catalyst precursor.

In steady state operations, a small amount of catalyst loss occurs through the filters and purging. These losses are offset by addition of fresh preformed catalyst concentrate at the front end of the process. Steady state catalyst concentrations in the reactor can vary widely over the range of about 100 ppm to 20 wt %. Preferably, the CHVB process is operated with a catalyst loading of about 0.1 wt % to 10 wt %, more preferably about 0.5 wt % to 5 wt %, based on the weight of the incoming feed. These higher catalyst concentrations are favored to promote conversion, hydrogen addition, demetallization, and desulfurization. Desulfurization is particularly sensitive to catalyst loading.

### EXAMPLES

### Example 1

Catalytic hydrovisbreaking lab tests were conducted using Cold Lake vacuum residual oil in autoclave reactors for 180 seconds at 870° F. (465.6° C.). Results are summarized in Table 1. It can be seen that catalytic hydrovisbreaking provided improved CCR conversion and greatly reduced coke as compared to visbreaking and hydrovisbreaking without catalysts.

TABLE 1

| Treat Gas | | | |
|---|---|---|---|
| (1300 psig | N₂ | H₂ | H₂ |
| (8963 kPa-gauge)) | (visbreaking) | (CHVB) | (hydrovisbreaking) |
| Catalyst load (ppmw) | 0 | 100 | 0 |
| 975° F.+ (523.9° C.+) | 35 | 48.1 | 48 |
| conversion % | | | |
| CCR conversion % | generates 10% | 15 | generates 2% |
| Coke wt % | Coil coked | 0.15 | 1.7 |

### Example 2

Related experiments were carried out using higher catalyst concentrations at a lower temperature of 775° F. (413° C.) and for 120 minutes using arab light vacuum resid. Table 2 below illustrates representative results. Higher catalyst concentrations improved metals removal, CCR conversion and increased saturates production.

TABLE 2

| | | |
|---|---|---|
| 1050° F.+ conversion | 50 | 53 |
| Catalyst load (wt %) | 0.6 | 2.4 |
| Demetallization % | 65 | 96 |
| CCR conversion % | 33 | 46 |
| Increase in saturates % | 12 | 15 |

While vacuum resid catalytic hydrovisbreaking is known for fuels processing, the integration of CHVB with a steam cracking furnace including an integrated knockout drum is not known. Moreover, use of CHVB processes with high catalyst concentrations and catalyst recycle is not well known. Those skilled in the art of heavy feed processing are familiar with the difficulties of operating heavy feed steam cracking and coking processes without fouling. It is not obvious how to integrate the processes without further aggravating these phenomena. The combination of catalytic hydrovisbreaking with a steam cracker using integrated knockout drums is particularly efficient and effective in this regard, as it enables high levels of vacuum resid conversion and allows cut points between the vapor and heavy liquids to be easily varied consistent with the properties of the feedstock and catalytic hydrovisbreaking product.

This invention further relates to:

1. A process, preferably continuous, for cracking hydrocarbon feedstock containing resid comprising:

(a) heating a hydrocarbon feedstock containing resid;

(b) adding molecular hydrogen to said heated feedstock to form a mixture stream;

(c) adding a catalyst containing metal-sulfide particles to said heated feedstock and/or said mixture stream;

(d) reacting said mixture in a catalytic hydrovisbreaking reactor under conditions of temperature, pressure and residence time sufficient to catalytically hydrovisbreak at least a portion of said resid into hydrovisbroken hydrocarbon components;

(e) passing said reacted mixture stream into a high pressure separator and separating hydrogen from said reacted mixture;

(f) passing said reacted mixture through a low pressure separator to remove catalyst and unreacted or uncracked resid as a bottoms stream; and

(g) passing said catalytically hydrovisbroken hydrocarbon components into a steam cracking furnace and thermally cracking said hydrocarbon components to form light olefins, alternately the knockout drum of step (f) is integrated into the steam cracking furnace of step (g).

2. The process of paragraph 1, wherein prior to step b) said hydrocarbon feedstock is heated in a convection section of a first steam cracking furnace, and further comprising separating (such as flashing) said heated hydrocarbon feedstock to form an overhead vapor phase and a liquid bottoms phase containing said resid in a first knockout drum integrated with said convection section of said first steam cracking furnace.
3. The process of paragraph 1 or 2, wherein the reacted mixture from step (e) is passed to the convection section of a steam cracker prior to entering the low pressure separator of step (f).
4. The process of paragraph 1, 2 or 3 wherein the steam cracking furnace of step (g) is a second steam cracking furnace comprising a second integrated knockout drum, wherein said catalytically hydrovisbroken hydrocarbon components are flashed to form an overhead vapor phase and an unconverted liquid bottoms phase.
5. The process of claim 1 wherein the process comprises:

(1) heating a hydrocarbon feedstock containing resid in a convection section of a first steam cracking furnace;

(2) passing said heated hydrocarbon feedstock containing resid to a first knockout drum integrated with said convection section of said first steam cracking furnace (and optionally mixing with steam) and separating (such as by flashing) said heated hydrocarbon feedstock to form an overhead vapor phase and a liquid bottoms phase containing said resid;

(3) adding molecular hydrogen to said liquid bottoms phase to form a mixture stream;

(4) adding a catalyst containing metal-sulfide particles to said liquid bottoms phase and/or said mixture stream;

(5) reacting said mixture in a catalytic hydrovisbreaking reactor under conditions of temperature, pressure and residence time sufficient to catalytically hydrovisbreak at least a portion of said resid into hydrovisbroken hydrocarbon components;

(6) passing said reacted mixture stream into a high pressure separator and separating hydrogen from said reacted mixture;

(7) optionally passing said reacted mixture to a convection section of a second steam cracking furnace;

(8) passing said reacted mixture exiting the high pressure separator and/or the convection section of the second steam cracking furnace through knockout drum integrated into the second steam cracking furnace to form a vapor phase containing catalytically hydrovisbroken hydrocarbon components and to remove catalyst and unreacted or uncracked resid as a bottoms stream; and

(9) passing the vapor phase containing catalytically hydrovisbroken hydrocarbon components into the radiant section of the second steam cracking furnace and thermally cracking said hydrocarbon components to form light olefins, or passing the vapor phase containing catalytically hydrovisbroken hydrocarbon components to the lower convection section for further preheating, then conveying to the radiant section of the second steam cracking furnace and thermally cracking said hydrocarbon components to form light olefins.

6. The process of paragraph 5 wherein hydrocarbon feedstock is not cooled when passing from the convection section of the first steam cracking furnace to the integrated first knockout drum.
7. The process of paragraph 5 or 6 where in the pressure of the liquid bottoms phase containing said resid produced in step (2) is increased prior to adding hydrogen and/or entering the catalytic hydrovisbreaking reactor.
8. The process of paragraph 5, 6 or 7 wherein the reacted mixture stream exiting the visbreaker is reduced in temperature prior to introduction into the high pressure separator.
9. The process of any of paragraphs 1 to 8, further comprising recovering said catalyst by filtering at least a portion of unconverted liquid bottoms from said second integrated knockout drum to form a retentate containing catalyst and a filtrate of unconverted liquid bottoms, and recycling said retentate containing catalyst into said catalytic hydrovisbreaking reactor, preferably said filtrate is blended with other refining process streams to produce fuel oil products.
10. The process of any of paragraphs 1 to 9, wherein said catalytic hydrovisbreaking reactor is charged with a catalyst load of between 0.1 wt % and 10 wt %, based on the weight of the hydrocarbon feedstock containing resid introduced into said reactor, preferably said catalytic hydrovisbreaking reactor is charged with a catalyst load of between 0.5 wt % and 7.5 wt %, preferably the catalyst load is between 0.5 wt % and 5 wt %.
11. The process of any of paragraphs 1 to 10, further comprising conducting said catalytic hydrovisbreaking under conditions sufficient to convert greater than 10 wt % of said resid, preferably greater than 60 wt % of said resid, preferably between 60 wt % and 80 wt % of said resid.
12. The process of any of paragraphs 1 to 11, where the catalytic hydrovisbreaking conditions include temperatures of 427-482° C., and/or a residence time of 2-100 minutes, and/or a hydrogen treat rate of 89-891 m³H₂/m³crude, and/or an operating pressure of 0.7-21 MPa-gauge, preferably the catalytic hydrovisbreaking conditions include temperatures of 438-460° C., and/or a residence time of 10 to 40 minutes, and/or a hydrogen treat rate of 178-445 m³H₂/m³crude, and/or an operating pressure of 3.45-17.2 MPa-gauge.
13. The process of any of paragraphs 1 to 12, wherein said hydrocarbon feedstock contains between 10 wt % and 50 wt % of resid boiling at 566° C.+.
14. The process of any of paragraphs 1 to 13 wherein the hydrovisbroken hydrocarbon components are passed into the steam cracker without condensation of the hydrovisbroken hydrocarbon components.
15. The process of any of paragraphs 1 to 14 wherein the hydrovisbroken hydrocarbon components comprise 40 wt % to 90 wt % less sulfur than the hydrocarbon feedstock containing resid.
16. The process of any of paragraphs 1 to 15 wherein the molecular hydrogen is added as a gas.
17. The process of paragraph 16, where in the gas is syngas.
18. A system, preferably continuous, for cracking hydrocarbon feedstock containing resid comprising:

(a) a first steam cracking furnace having a first knockout drum integrated with a convection section of said first furnace;

(b) a catalytic hydrovisbreaking reactor downstream of and in fluid communication with a liquid bottoms extraction portion of said first knockout drum; and

(c) a second steam cracking furnace having a second knockout drum integrated with a convection section of said second furnace, and a radiant cracking section;

wherein an inlet of said second steam cracking furnace is downstream of and in fluid communication with said catalytic hydrovisbreaking reactor, and a liquid bottoms extraction portion of said second knockout drum is in fluid communication with said catalytic hydrovisbreaking reactor.
19. The system of paragraph 18, further comprising a stripping gas line connected to said second knockout drum.
20. The system of paragraph 18 or 19, further comprising a filtration unit disposed between the liquid bottoms extraction portion of said second knockout drum and said catalytic hydrovisbreaker reactor.

In any of the embodiments described herein the units include heat integration among and within each unit operation, especially the steam cracking furnaces, particularly the second steam cracking furnace.

Unless otherwise specified, the meanings of terms used herein shall take their ordinary meaning in the art; reference shall be taken, in particular, to Handbook of Petroleum Refining Processes, Third Edition, Robert A. Meyers, Editor, McGraw-Hill (2004). In addition, all patents and patent applications, test procedures (such as ASTM methods), and other documents cited herein are fully incorporated by reference to the extent such disclosure is not inconsistent with this invention and for all jurisdictions in which such incorporation is permitted. Also, when numerical lower limits and numerical upper limits are listed herein, ranges from any lower limit to any upper limit are contemplated. Note further that trade names used herein are indicated by a ™ symbol or ® symbol, indicating that the names may be protected by certain trademark rights, e.g., they may be registered trademarks in various jurisdictions.

The invention has been described above with reference to numerous embodiments and specific examples. Many variations will suggest themselves to those skilled in this art in light of the above detailed description. All such obvious variations are within the full intended scope of the appended claims.

What is claimed is:

1. A process for cracking hydrocarbon feedstock containing resid comprising:
(a) heating a hydrocarbon feedstock containing resid;
(b) adding molecular hydrogen to said heated feedstock to form a mixture stream;
(c) adding a catalyst containing metal-sulfide particles to said heated feedstock and/or said mixture stream;
(d) reacting said mixture in a catalytic hydrovisbreaking reactor under conditions of temperature, pressure and residence time sufficient to catalytically hydrovisbreak at least a portion of said resid into hydrovisbroken hydrocarbon components;
(e) passing said reacted mixture stream into a high pressure separator and separating hydrogen from said reacted mixture;
(f) passing said reacted mixture through a knockout drum to remove catalyst and unreacted or uncracked resid as a bottoms stream; and
(g) passing said catalytically hydrovisbroken hydrocarbon components into a steam cracking furnace and thermally cracking said hydrocarbon components to form light olefins.

2. The process of claim 1, wherein prior to step b) said hydrocarbon feedstock is heated in a convection section of a first steam cracking furnace and mixed with steam, and further comprising separating said heated hydrocarbon feedstock to form an overhead vapor phase and a liquid bottoms phase containing said resid in a first knockout drum integrated with said convection section of said first steam cracking furnace.

3. The process of claim 2, wherein the reacted mixture from step (e) is passed to the convection section of a steam cracker prior to entering the knockout drum of step (f) and wherein the steam cracking furnace of step (g) is a second steam cracking furnace comprising a second integrated knockout drum, wherein said catalytically hydrovisbroken hydrocarbon components are flashed to form an overhead vapor phase and an unconverted liquid bottoms phase.

4. The process of claim 3, further comprising recovering said catalyst by filtering at least a portion of unconverted liquid bottoms from said second integrated knockout drum to form a retentate containing catalyst and a filtrate of unconverted liquid bottoms, and recycling said retentate containing catalyst into said catalytic hydrovisbreaking reactor.

5. The process of claim 4, further comprising blending said filtrate with other refining process streams to produce fuel oil products.

6. The process of claim 1, wherein said catalytic hydrovisbreaking reactor is charged with a catalyst load of between 0.1 wt % and 10 wt %, based on the weight of the hydrocarbon feedstock containing resid introduced into said reactor.

7. The process of claim 1, wherein said catalytic hydrovisbreaking reactor is charged with a catalyst load of between 0.5 wt % and 7.5 wt %, based on the weight of the hydrocarbon feedstock containing resid introduced into said reactor.

8. The process of claim 6, wherein the catalyst load is between 0.5 wt % and 5 wt %, based on the weight of the hydrocarbon feedstock containing resid introduced into said hydrovisbreaking reactor.

9. The process of claim 1, further comprising conducting said catalytic hydrovisbreaking under conditions sufficient to convert greater than 60 wt % of said resid.

10. The process of claim 1, further comprising conducting said catalytic hydrovisbreaking under conditions sufficient to convert between 60 wt % and 80 wt % of said resid.

11. The process of claim 1, where the catalytic hydrovisbreaking conditions include temperatures of 427-482° C., a residence time of 2-100 minutes, a hydrogen treat rate of 89-891 m³H₂/m³crude, and an operating pressure of 0.7-21 MPa-gauge.

12. The process of claim 1, where the catalytic hydrovisbreaking conditions include temperatures of 438-460° C., a residence time of 10 to 40 minutes, a hydrogen treat rate of 178-445 m³H₂/m³crude, and an operating pressure of 3.45-17.2 MPa-gauge.

13. The process of claim 1, wherein said hydrocarbon feedstock contains between 10 wt % and 50 wt % of resid boiling at 566° C.+.

14. The process of claim 1, wherein the hydrovisbroken hydrocarbon components are passed into the steam cracker without condensation of the hydrovisbroken hydrocarbon components.

15. The process of claim 1, wherein the hydrovisbroken hydrocarbon components comprise 40 wt % to 90 wt % less sulfur than the hydrocarbon feedstock containing resid.

16. The process of claim 1, wherein the molecular hydrogen is added as a gas.

17. The process of claim 16, where in the gas is syngas.

18. A system for cracking hydrocarbon feedstock containing resid comprising:
(a) a first steam cracking furnace having a first knockout drum integrated with a convection section of said first furnace;
(b) a catalytic hydrovisbreaking reactor downstream of and in fluid communication with a liquid bottoms extraction portion of said first knockout drum; and
(c) a second steam cracking furnace having a second knockout drum integrated with a convection section of said second furnace, and a radiant cracking section;
wherein an inlet of said second steam cracking furnace is downstream of and in fluid communication with said catalytic hydrovisbreaking reactor, and a liquid bottoms extraction portion of said second knockout drum is in fluid communication with said catalytic hydrovisbreaking reactor.

19. The system of claim 18, further comprising a stripping gas line connected to said second knockout drum.

20. The system of claim 18, further comprising a filtration unit disposed between the liquid bottoms extraction portion of said second knockout drum and said catalytic hydrovisbreaker reactor.

21. A process for cracking hydrocarbon feedstock containing resid comprising:
(1) heating a hydrocarbon feedstock containing resid in a convection section of a first steam cracking furnace;
(2) passing said heated hydrocarbon feedstock containing resid to a first knockout drum integrated with said convection section of said first steam cracking furnace (optionally mixing with steam) and separating said heated hydrocarbon feedstock to form an overhead vapor phase and a liquid bottoms phase containing said resid;
(3) adding molecular hydrogen to said liquid bottoms phase to form a mixture stream;
(4) adding a catalyst containing metal-sulfide particles to said liquid bottoms phase and/or said mixture stream;
(5) reacting said mixture in a catalytic hydrovisbreaking reactor under conditions of temperature, pressure and residence time sufficient to catalytically hydrovisbreak at least a portion of said resid into hydrovisbroken hydrocarbon components;
(6) passing said reacted mixture stream into a high pressure separator and separating hydrogen from said reacted mixture;
(7) optionally passing said reacted mixture to a convection section of a second steam cracking furnace;
(8) passing said reacted mixture exiting the high pressure separator and/or the convection section of the second steam cracking furnace through a knockout drum integrated into the second steam cracking furnace to form a vapor phase containing catalytically hydrovisbroken hydrocarbon components and to remove catalyst and unreacted or uncracked resid as a bottoms stream; and
(9) passing the vapor phase containing catalytically hydrovisbroken hydrocarbon components into the radiant section of the second steam cracking furnace and thermally cracking said hydrocarbon components to form light olefins.

22. The process of claim 21, further comprising recovering said catalyst by filtering at least a portion of unconverted liquid bottoms from said second integrated knockout drum to form a retentate containing catalyst and a filtrate of unconverted liquid bottoms, and recycling said retentate containing catalyst into said catalytic hydrovisbreaking reactor.

23. The process of claim 21, wherein said catalytic hydrovisbreaking reactor is charged with a catalyst load of between 0.1 wt % and 10 wt %, based on the weight of the hydrocarbon feedstock containing resid introduced into said reactor.

24. The process of claim 21, further comprising conducting said catalytic hydrovisbreaking under conditions sufficient to convert greater than 10 wt % of said resid.

25. The process of claim 21, further comprising conducting said catalytic hydrovisbreaking under conditions sufficient to convert between 60 wt % and 80 wt % of said resid.

26. The process of claim 21, where the catalytic hydrovisbreaking conditions include temperatures of 427-482° C., a residence time of 2-100 minutes, a hydrogen treat rate of 89-891 m³H₂/m³crude, and an operating pressure of 0.7-21 MPa-gauge.

27. The process of claim 21, wherein said hydrocarbon feedstock contains between 10 wt % and 50 wt % of resid boiling at 566° C.+.

28. The process of claim 21, wherein said hydrocarbon feedstock is not cooled when passing from the convection section of the first steam cracking furnace to the integrated first knockout drum.

29. The process of claim 21, where in the pressure of the liquid bottoms phase containing said resid produced in step (2) is increased prior to adding hydrogen and/or entering the catalytic hydrovisbreaking reactor.

30. The process of claim 21, wherein the reacted mixture stream exiting the visbreaker is reduced in temperature prior to introduction into the high pressure separator.

31. A process for cracking hydrocarbon feedstock containing resid comprising:
(a) heating a hydrocarbon feedstock containing resid;
(b) adding molecular hydrogen to said heated feedstock to form a mixture stream;
(c) adding a catalyst containing metal-sulfide particles to said heated feedstock and/or said mixture stream;
(d) reacting said mixture in a catalytic hydrovisbreaking reactor under conditions of temperature, pressure and residence time sufficient to catalytically hydrovisbreak at least a portion of said resid into hydrovisbroken hydrocarbon components;
(e) passing said reacted mixture stream into a high pressure separator and separating hydrogen from said reacted mixture; and
(f) passing said catalytically hydrovisbroken hydrocarbon components into a steam cracking furnace and thermally cracking said hydrocarbon components to form light olefins.

32. The process of claim 31, wherein prior to step b) said hydrocarbon feedstock is heated in a convection section of a first steam cracking furnace, and further comprising flashing said heated hydrocarbon feedstock to form an overhead vapor phase and a liquid bottoms phase containing said resid in a first knockout drum integrated with said convection section of said first steam cracking furnace.

33. The process of claim 31, wherein the steam cracking furnace of step (g) comprises an integrated knockout drum where said catalytically hydrovisbroken hydrocarbon components are flashed to form an overhead vapor phase and an unconverted liquid bottoms phase.

34. The process of claim 32, wherein the steam cracking furnace of step (g) comprises an integrated knockout drum where said catalytically hydrovisbroken hydrocarbon components are flashed to form an overhead vapor phase and an unconverted liquid bottoms phase.

35. The process of claim 1, wherein the process is continuous.
